(19) United States
(12) Patent Application Publication
(10) Pub. No.: US 2007/0085663 A1
(43) Pub. Date: Apr. 19, 2007

(54) Data exchange systems and methods employing RF data transmission

(76) Inventors: Clifford J. August, Vancouver (CA); Henry Hon-Yiu Leung, Coquitlam (CA); Thomas Heinrich Sternberg, Delta (CA)

Correspondence Address: SCHACHT LAW OFFICE, INC., SUITE 202, 2801 MERIDIAN STREET, BELLINGHAM, WA, 98225-2412, US

(21) Appl. No.: 11/583,461

(22) Filed: Oct. 18, 2006

Related U.S. Application Data
(60) Provisional application No. 60/727,387, filed on Oct. 18, 2005.
(60) Provisional application No. 60/727,388, filed on Oct. 18, 2005.
(60) Provisional application No. 60/727,389, filed on Oct. 18, 2005.
(60) Provisional application No. 60/727,393, filed on Oct. 18, 2005.

(51) Int. Cl. H04Q 5/22

(52) U.S. Cl. 340/10.1; 340/572.1; 341/22; 379/433.06

(57) ABSTRACT

A data exchange system for exchanging data with a host device, comprising at least one button assembly and a dock assembly. The at least one button assembly comprises an encoder, a button coil, and a switch, where closing the switch forms an antenna circuit. The dock assembly comprising a controller, at least one dock coil, a decoder, and at least one interface. The controller causes the decoder to obtain data from the encoder through the button coil and the dock coil when the switch is closed. The controller further transfers the data to the at least one interface. The at least one interface transfers the data to the host device.

### RELATED APPLICATIONS

This application claims priority of U.S. Provisional Patent Application Ser. Nos. 60/727,387 filed Oct. 18, 2005, 60/727,388 filed Oct. 18, 2005, 60/727,389 filed Oct. 18, 2005, and 60/727,393 filed Oct. 18, 2005, the contents of which are incorporated herein by reference.

### TECHNICAL FIELD

The present invention relates to radio frequency identification (RFID) systems and, in particular, to RFID systems that store data in a manner that allows the downloading of data to be controlled.

### BACKGROUND OF THE INVENTION

RFID systems are becoming ubiquitous in everyday life. An RFID system contains two basic elements: a tag unit and an interrogator unit. The tag unit typically comprises an IC and an antenna. The IC comprises memory and processing circuitry. The interrogator unit contains an RF transceiver, processing circuitry, and an antenna. Power to the tag IC may be provided by the interrogator unit, so the tag unit need not contain a power storage system such as a battery. A tag unit that does not contain a power storage system is referred to as a passive tag unit. The interrogator portion may generate a signal that activates any tag unit within reach of the signal. When activated, any tag unit within signal reach transmits any data stored on the memory to the interrogator unit.

In many contexts, the data stored by a tag unit is not confidential. However, in other contexts, it may be desirable to limit access to the data stored on a tag unit. The present invention relates to RFID systems and methods designed to limit access to data stored on a tag unit.

The present invention is of particular significance in the context of a button assembly that stores personal information such as telephone numbers, addresses, and the like. The present invention will thus be described herein in the context of RFID systems and methods that allow personal data to be transmitted from a button assembly to an electronic device such as a telephone or computer for storage and/or further processing. However, the principles of the present invention may have broader application, and the principles of the present invention should be determined by the claims appended hereto and not the following detailed description of the invention.

### SUMMARY OF THE INVENTION

The present invention may be embodied as a data exchange system for exchanging data with a host device, comprising at least one button assembly and a dock assembly. The at least one button assembly comprises an encoder, a button coil, and a switch, where closing the switch forms an antenna circuit. The dock assembly comprising a controller, at least one dock coil, a decoder, and at least one interface. The controller causes the decoder to obtain data from the encoder through the button coil and the dock coil when the switch is closed. The controller further transfers the data to the at least one interface. The at least one interface transfers the data to the host device.

### BRIEF DESCRIPTION OF THE DRAWINGS

FIG. 1 is a block diagram of a first example data exchange system constructed in accordance with, and embodying, the principles of the present invention;

FIG. 2 is a block diagram of a second example data exchange system constructed in accordance with, and embodying, the principles of the present invention;

FIG. 3 is a block diagram of a third example data exchange system constructed in accordance with, and embodying, the principles of the present invention;

FIG. 4 is a block diagram of a fourth example data exchange system constructed in accordance with, and embodying, the principles of the present invention;

FIG. 5 is a block diagram of a fifth example data exchange system constructed in accordance with, and embodying, the principles of the present invention;

FIG. 6 is a block diagram of a sixth example data exchange system constructed in accordance with, and embodying, the principles of the present invention;

FIG. 7 is a circuit diagram of an example telephone interface and power supply interface that may be used by the first, fifth, and sixth example data exchange systems described above;

FIG. 8 is a circuit diagram of an example microphone interface that may be used by the second, third, and sixth data exchange systems described above;

FIG. 9 depicts the relationship of an example of an eight-bit byte and a cycle used to create a pulse-width modulated signal;

FIG. 10 depicts a pulse-width modulated signal created by the byte depicted in FIG. 9;

FIG. 11 depicts a first configuration of a seventh example data exchange system of the present invention; and

FIG. 12 depicts a second configuration of the seventh example data exchange system depicted in FIG. 11.

### DETAILED DESCRIPTION OF THE INVENTION

The principles of the present invention may be embodied in many different forms, and six example data exchange systems using the principles of the present invention will be described below.

### I. First Example Data Exchange System

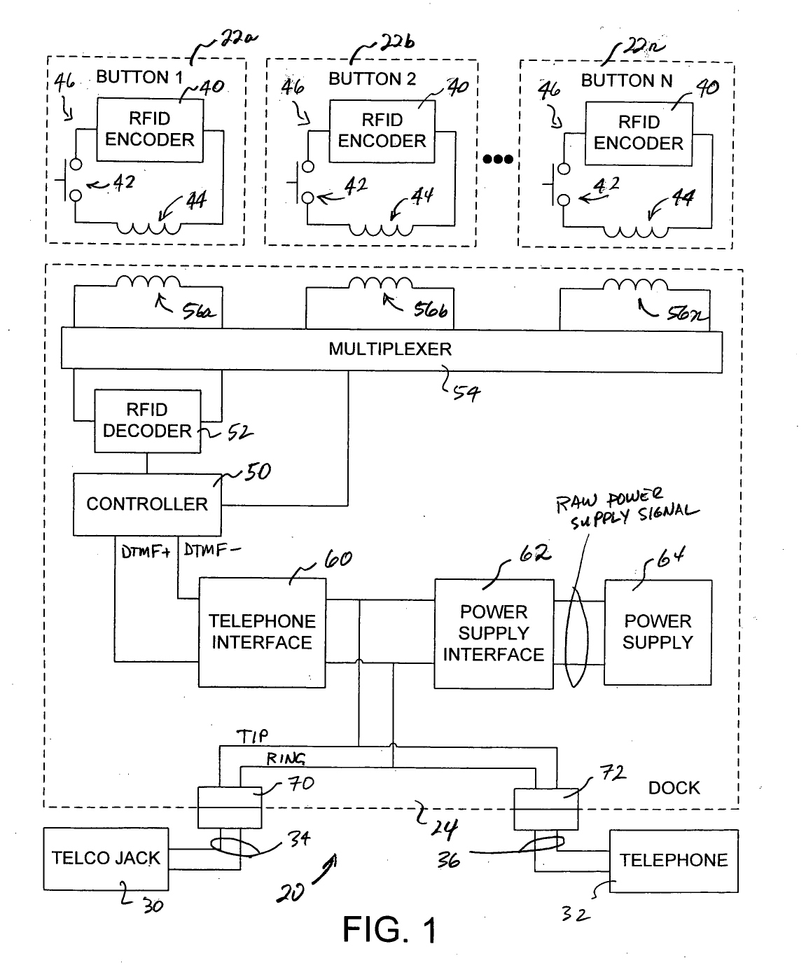

Referring initially to FIG. 1 of the drawing, depicted at 20 therein is a first example data exchange system constructed in accordance with, and embodying, the principles of the present invention. The first example data exchange system 20 comprises a plurality of button assemblies 22a, 22b, and 22n and a dock assembly 24. As will be described in further detail below, the dock assembly 24 is connected between a TELCO jack 30 and a telephone 32 by first and second cable assemblies 34 and 36.

Each button assembly comprises an RFID encoder 40, a switch 42, and a button coil 44. When the switch 42 is in a closed state, an antenna circuit 46 is formed that includes the RFID encoder 40 and the button coil 44. When the switch 42 is closed, the antenna circuit 46 allows the RFID encoder 40 to be energized. When energized, the RFID encoder 40 generates an RF data signal that is transmitted from the button coil 44. The RF data signal contains data stored by the RFID encoder 40.

The example dock assembly 24 comprises a controller 50, an RFID decoder 52, a multiplexer 54, and a plurality of dock coils 56a, 56b, and 56n. The example dock assembly 24 further comprises a telephone interface 60, a power supply interface 62, a power supply 64, a first jack 70, and a second jack 72.

The controller 50 operates the multiplexer 54 to connect a selected one of the dock coils 56 to the RFID decoder 52. The controller 50 further operates the RFID decoder 52 to energize the selected dock coil 56. Typically, the controller 50 will cycle among the plurality of dock coils 56 if more than one dock coil 56 is used.

When the selected dock coil 56 is energized by the RFID decoder 52 as described above, the selected dock coil 56 transmits an RF power signal. If the button coil 44 of any one of the button assemblies 22a-n is within range of the RF power signal generated by the selected dock coil 56, any button coil 44 adjacent to the selected dock coil 56 converts the RF power signal into a current capable of energizing the RFID encoder 40 connected to the adjacent button coil 44.

If the switch 42 connected to the button coil 44 that receives the RF power signal is open, the antenna circuit 36 is not formed, and the RFID encoder 40 is not energized. If, however, the switch 42 connected to the button coil 44 that receives the RF power signal is closed, the antenna circuit 36 is formed, and the adjacent button coil 44 generates a current that energizes the RFID encoder 40. As described above, the RFID encoder 40 generates the RF data signal when energized. The adjacent button coil 44 transmits the RF data signal to the selected dock coil 56 adjacent thereto.

The selected dock coil 56 receives the RF data signal and converts the RF data signal into a current that is received by the RFID decoder 52 through the multiplexer 54. The RFID decoder 52 extracts from the RF data signal the data stored by the RFID encoder 40 connected to the adjacent button coil 44.

The RFID encoder 40 then passes the extracted data to the controller 50. In the example data exchange system 20, the extracted data corresponds to a telephone number or a portion of a telephone number. The controller 50 generates DTMF signals corresponding to the telephone number or portion of a telephone number. The controller 50 may generate the DTMF signals using conventional pulse-width modulation techniques or a DTMF generation system as will be described in further detail below.

The telephone interface 60 conditions the DTMF signal as appropriate for applying to the TIP and RING lines of a conventional telephone system. In particular, the first cable 34 is connected between the TELCO jack 30 and the first jack 70, and the second cable 34 is connected between the second jack 72 and the telephone 32. A twisted pair carrying the TIP and RING lines is available between the first and second jacks 70 and 72. The telephone interface 60 applies the DTMF signal to the TIP and RING lines in a conventional manner.

FIG. 1 further illustrates that the power supply interface 62 is connected to the TIP and RING lines. The power supply interface 62 generates a raw power supply signal and applies this raw power signal to the power supply 64 in accordance to local telecommunications standard. The power supply 64 converts the raw power signal into a system power supply signal appropriate for powering the controller 50, RFID decoder 52, telephone interface 60, and power supply interface 62 in a conventional manner. By obtaining power from the TIP and RING lines, the dock assembly 24 does not require utility or battery power.

The RFID encoder 40 and RFID decoder 52 are or may be conventional. The RFID system formed by the encoder 40 and decoder 52 can be used both to transmit data from the button assemblies 22 to the dock 24 and, under appropriate conditions, from a conventional RFID programming system to the RFID encoder 40 of the button assemblies 22. Alternatively, data may be stored directly onto the RFID encoder 40 using electrical contacts.

The first example data exchange system 20 is appropriate for use with POTS systems where limited power is available on the TIP and RING lines and the DTMF signals can be injected directly into the TIP and RING lines.

### II. Second Example Data Exchange System

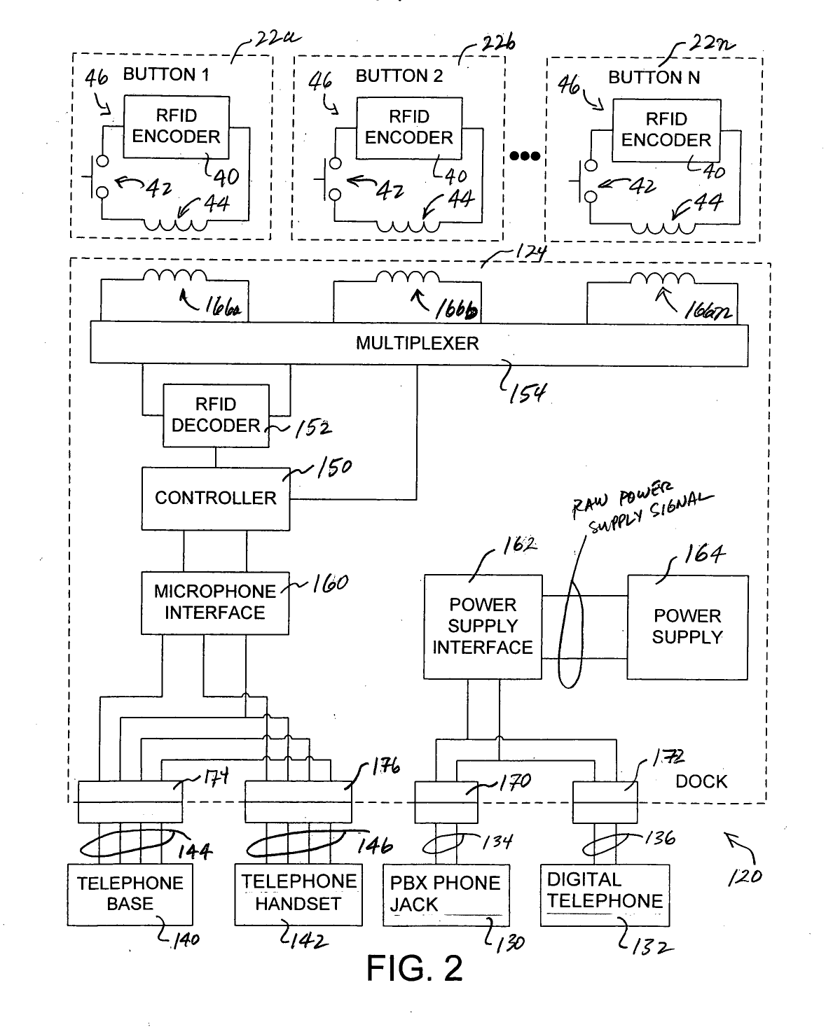

Referring now to FIG. 2 of the drawing, depicted at 120 therein is a second example data exchange system constructed in accordance with, and embodying, the principles of the present invention. The second example data exchange system 120 comprises a plurality of the button assemblies 22a, 22b, and 22n and a dock assembly 124.

As will be described in further detail below, the dock assembly 124 is connected between a PBX PHONE jack 130 and a digital telephone 132 by first and second cable assemblies 134 and 136. In the example system 120, the dock assembly 124 is additionally connected between a telephone base 140 and a telephone handset 142 by cables 144 and 146. The button assemblies 22a-n described above may also be used in connection with the dock assembly 124 as will be described in further detail below.

The example dock assembly 124 comprises a controller 150, an RFID decoder 152, a multiplexer 154, and a plurality of dock coils 156a, 156b, and 156n. The example dock assembly 124 further comprises a microphone interface 160, a power supply interface 162, a power supply 164, a first jack 170, a second jack 172, a third jack 174, and a fourth jack 176. The controller 150 operates the multiplexer 154 to connect a selected one of the dock coils 156 to the RFID decoder 152. The controller 150 further operates the RFID decoder 152 to energize the selected dock coil 156.

When the selected dock coil 156 is energized by the RFID decoder 152 as described above, the selected dock coil 156 transmits an RF power signal. If the button coil 144 of any one of the button assemblies 122a-n is within range of the RF power signal generated by the selected dock coil 156, any button coil 144 adjacent to the selected dock coil 156 converts the RF power signal into a current capable of energizing the RFID encoder 140 connected to the adjacent button coil 144.

If the switch 142 connected to the button coil 144 that receives the RF power signal is open, the antenna circuit 136 is not formed, and the RFID encoder 140 is not energized. If, however, the switch 142 connected to the button coil 144 that receives the RF power signal is closed, the antenna circuit 136 is formed, and the adjacent button coil 144 generates a current that energizes the RFID encoder 140. As described above, the RFID encoder 140 generates the RF data signal when energized. The adjacent button coil 144 transmits the RF data signal to the selected dock coil 156 adjacent thereto.

The selected dock coil 156 receives the RF data signal and converts the RF data signal into a current that is received by the RFID decoder 152 through the multiplexer 154. The RFID decoder 152 extracts from the RF data signal the data stored by the RFID encoder 140 connected to the adjacent button coil 144.

The RFID encoder 140 then passes the extracted data to the controller 150. In the example data exchange system 120, the extracted data corresponds to a telephone number or a portion of a telephone number. The controller 150 generates DTMF signals corresponding to the telephone number or portion of a telephone number. The controller 150 may generate the DTMF signals using conventional pulse-width modulation techniques or a DTMF generation system as will be described in further detail below.

The microphone interface 160 conditions the DTMF signal as appropriate for application to the microphone lines of a conventional telephone. The microphone interface 160 applies the DTMF signal to the microphone lines such that, when the telephone base 140 is in the “off hook” state, the DTMF signals are passed through to the phone lines connected to the telephone base 140.

FIG. 2 further illustrates that the first cable 134 is connected between the PBX TELCO jack 130 and the first jack 170, and the second cable 134 is connected between the second jack 172 and the digital telephone 132. Several conductors carrying the voice and power signals are thus available between the first and second jacks 170 and 172. The power supply interface 166 is connected to the power lines. The power supply interface 166 generates a raw power supply signal and applies this raw power signal to the power supply 164. The power supply 164 converts the raw power signal into a system power supply signal appropriate for powering the controller 150, RFID decoder 152, microphone interface 160, and power supply interface 166 in a conventional manner. By obtaining power from the PBX power lines, the dock assembly 124 does not require utility or battery power.

The RFID encoder 140 and RFID decoder 152 are or may be conventional. The RFID system formed by the encoder 140 and decoder 152 can be used both to transmit data from the button assemblies 122 to the dock 124 and, under appropriate conditions, from a conventional RFID programming system to the RFID encoder 140 of the button assemblies 122. Alternatively, data may be stored directly onto the RFID encoder 140 using electrical contacts. In either case, a computer interface may be provided to facilitate use of the RFID interface system by casual users.

The second example data exchange system 120 is appropriate for use with PBX telephone system where power is available on the TIP and RING lines but the DTMF signals cannot be injected directly into the TIP and RING lines.

### III. Third Example Data Exchange System

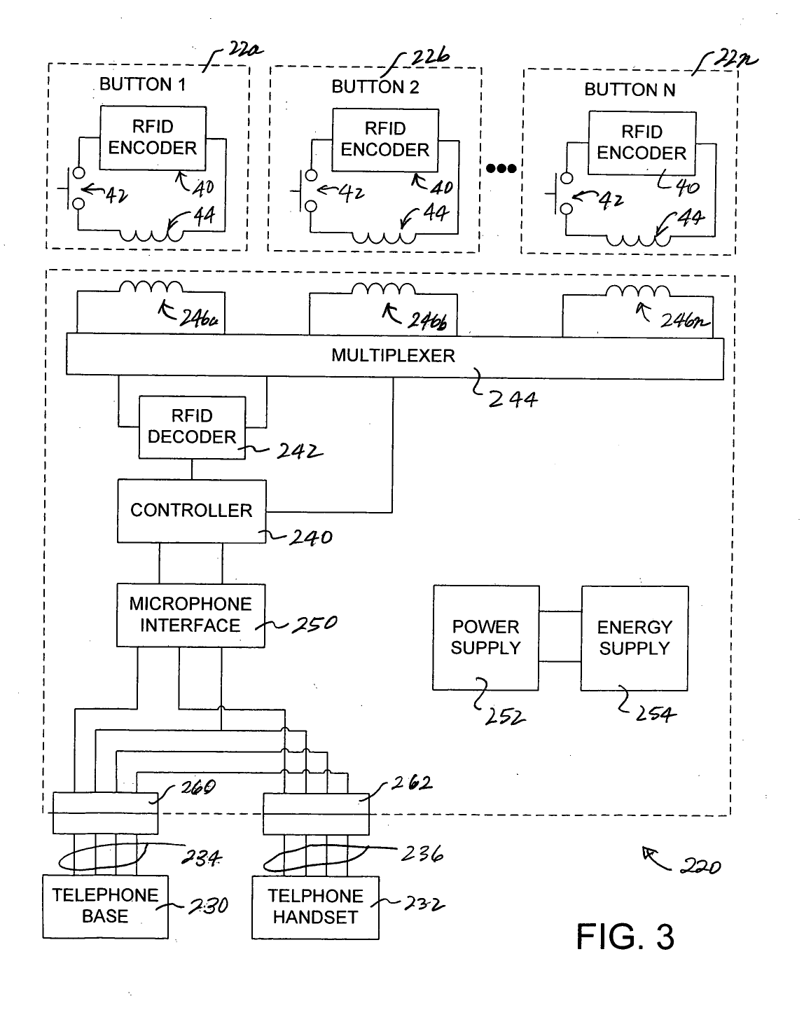

Referring now to FIG. 3 of the drawing, depicted at 220 therein is a third example data exchange system constructed in accordance with, and embodying, the principles of the present invention. The third example data exchange system 220 comprises a plurality of the button assemblies 22a, 22b, and 22n and a dock assembly 224.

In the example system 220, the dock assembly 224 is connected between a telephone base 230 and a telephone handset 232 by cables 234 and 236. The button assemblies 22a-n described above may also be used in connection with the dock assembly 224 as will be described in further detail below.

The example dock assembly 224 comprises a controller 240, an RFID decoder 242, a multiplexer 244, and a plurality of dock coils 246a, 246b, and 246n. The example dock assembly 224 further comprises a microphone interface 250, a power supply 252, an energy supply 254, a first jack 260, and a second jack 262. The controller 240 operates the multiplexer 244 to connect a selected one of the dock coils 246 to the RFID decoder 242. The controller 240 further operates the RFID decoder 242 to energize the selected dock coil 246.

When the selected dock coil 246 is energized by the RFID decoder 242 as described above, the selected dock coil 246 transmits an RF power signal. If the button coil 234 of any one of the button assemblies 222a-n is within range of the RF power signal generated by the selected dock coil 246, any button coil 234 adjacent to the selected dock coil 246 converts the RF power signal into a current capable of energizing the RFID encoder 230 connected to the adjacent button coil 234.

If the switch 232 connected to the button coil 234 that receives the RF power signal is open, the antenna circuit 46 is not formed, and the RFID encoder 230 is not energized. If, however, the switch 232 connected to the button coil 234 that receives the RF power signal is closed, the antenna circuit 46 is formed, and the adjacent button coil 234 generates a current that energizes the RFID encoder 230. As described above, the RFID encoder 230 generates the RF data signal when energized. The adjacent button coil 234 transmits the RF data signal to the selected dock coil 246 adjacent thereto.

The selected dock coil 246 receives the RF data signal and converts the RF data signal into a current that is received by the RFID decoder 242 through the multiplexer 244. The RFID decoder 242 extracts from the RF data signal the data stored by the RFID encoder 230 connected to the adjacent button coil 234.

The RFID encoder 230 then passes the extracted data to the controller 240. In the example data exchange system 220, the extracted data corresponds to a telephone number or a portion of a telephone number. The controller 240 generates DTMF signals corresponding to the telephone number or portion of a telephone number. The controller 240 may generate the DTMF signals using conventional pulse-width modulation techniques or a DTMF generation system as will be described in further detail below.

The microphone interface 250 conditions the DTMF signal as appropriate for application to the microphone lines of a conventional telephone. The microphone interface 250 applies the DTMF signal to the microphone lines such that, when the telephone base 230 is in the “off hook” state, the DTMF signals are passed through to the PBX lines connected to the telephone base 230.

FIG. 3 illustrates that the power supply 252 obtains energy from an energy supply 254. The energy supply 254 may be utility power or a battery. In either case, the power supply 252 generates a system power supply signal appropriate for powering the controller 240, RFID decoder 242, and microphone interface 250in a conventional manner.

The RFID encoder 230 and RFID decoder 242 are or may be conventional. The RFID system formed by the encoder 230 and decoder 242 can be used both to transmit data from the button assemblies 222 to the dock 224 and, under appropriate conditions, from a conventional RFID programming system to the RFID encoder 230 of the button assemblies 222. Alternatively, data may be stored directly onto the RFID encoder 230 using electrical contacts.

### IV. Fourth Example Data Exchange System

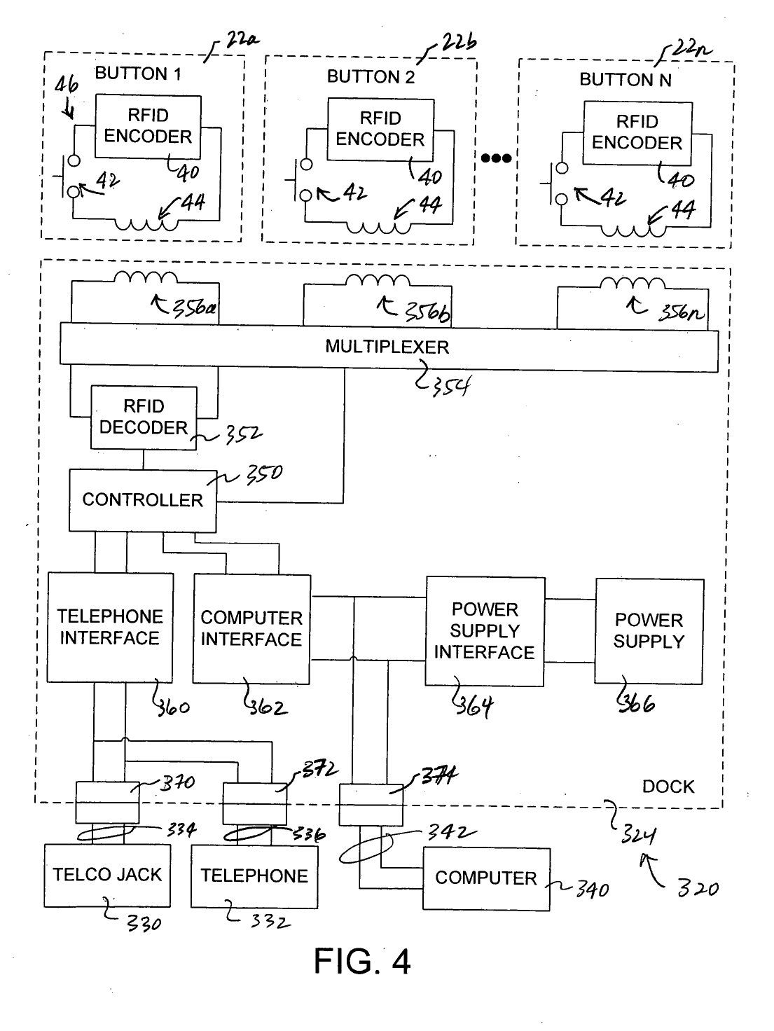

Referring now to FIG. 4 of the drawing, depicted at 320 therein is a fourth example data exchange system constructed in accordance with, and embodying, the principles of the present invention. The fourth example data exchange system 320 comprises a plurality of the button assemblies 22a, 22b, and 22n and a dock assembly 324. The button assemblies 22a-n described above may also be used in connection with the dock assembly 324 as will be described in further detail below.

As will be described in further detail below, the dock assembly 324 is connected between a TELCO jack 330 and a telephone 332 by first and second cable assemblies 334 and 336. In the example system 320, the dock assembly 324 is additionally connected to a computing device 340 by a cable 342. The computing device 340 may be a general purpose computer, personal digital assistant, cellular telephone, camera, MP3 player, or any other device capable of receiving digital data.

The example dock assembly 324 comprises a controller 350, an RFID decoder 352, a multiplexer 354, and a plurality of dock coils 356a, 356b, and 356n. The example dock assembly 324 further comprises a microphone interface 360, a computer interface 362, a power supply interface 364, a power supply 366, a first jack 370, a second jack 372, and a third jack 374. The controller 350 operates the multiplexer 354 to connect a selected one of the dock coils 356 to the RFID decoder 352. The controller 350 further operates the RFID decoder 352 to energize the selected dock coil 356.

When the selected dock coil 356 is energized by the RFID decoder 352 as described above, the selected dock coil 356 transmits an RF power signal. If the button coil 344 of any one of the button assemblies 322a-n is within range of the RF power signal generated by the selected dock coil 356, any button coil 344 adjacent to the selected dock coil 356 converts the RF power signal into a current capable of energizing the RFID encoder 340 connected to the adjacent button coil 344.

If the switch 342 connected to the button coil 344 that receives the RF power signal is open, the antenna circuit 336 is not formed, and the RFID encoder 340 is not energized. If, however, the switch 342 connected to the button coil 344 that receives the RF power signal is closed, the antenna circuit 336 is formed, and the adjacent button coil 344 generates a current that energizes the RFID encoder 340. As described above, the RFID encoder 340 generates the RF data signal when energized. The adjacent button coil 344 transmits the RF data signal to the selected dock coil 356 adjacent thereto.

The selected dock coil 356 receives the RF data signal and converts the RF data signal into a current that is received by the RFID decoder 352 through the multiplexer 354. The RFID decoder 352 extracts from the RF data signal the data stored by the RFID encoder 340 connected to the adjacent button coil 344.

The RFID encoder 340 then passes the extracted data to the controller 350. In the example data exchange system 320, the extracted data corresponds to at least a telephone number or a portion of a telephone number. The controller 350 generates DTMF signals corresponding to the telephone number or portion of a telephone number. The controller 350 may generate the DTMF signals using conventional pulse-width modulation techniques or a DTMF generation system as will be described in further detail below.

The microphone interface 360 conditions the DTMF signal as appropriate for application to the microphone lines of a conventional telephone. The microphone interface 360 applies the DTMF signal to the microphone lines such that, when the telephone base 340 is in the “off hook” state, the DTMF signals are passed through to the TIP and RING lines connected to the telephone base 340.

In addition to telephone number data, the extracted data may further contain personal information such as individual name, company name, address, songs, video clips, audio clips, resume data, playlist data, and the like. The controller 350 further generates a digital data signal based on the extracted data, where the digital data signal contains the contact information. The controller 350 is connected to the computer interface 362 to transfer the digital data signal to the computer interface 362. The computer interface 362 in turn transfers the extracted data to the computing device 340 through the third port 374 and the third cable 342.

Certain data communication standards allow not only digital data but power to be transferred from a computing device to a peripheral device. In the case of the computing device 340, the cable 342 is a USB cable that carries a USB power signal and digital data. Accordingly, FIG. 4 further illustrates that the power supply interface 364 is connected to the third jack 374 and generates a raw power supply signal based on the USB power signal. The power supply interface 364 applies the raw power signal to the power supply 366. The power supply 366 converts the raw power signal into a system power supply signal appropriate for powering the controller 350, RFID decoder 352, microphone interface 360, computer interface 362, and power supply interface 364 in a conventional manner. By obtaining power from the USB cable 342, the dock assembly 324 does not require utility or battery power.

The RFID encoder 340 and RFID decoder 352 are or may be conventional. The RFID system formed by the encoder 340 and decoder 352 can be used both to transmit data from the button assemblies 322 to the dock 324 and, under appropriate conditions, from a conventional RFID programming system to the RFID encoder 340 of the button assemblies 322. Alternatively, data may be stored directly onto the RFID encoder 340 using electrical contacts.

Although the data exchange system 320 employs a telephone interface 360 and is connected between the TELCO jack 330 and the telephone 332, the system 320 may easily be modified to include a microphone interface that is connected between a telephone base and a telephone handset.

### V. Fifth Example Data Exchange System

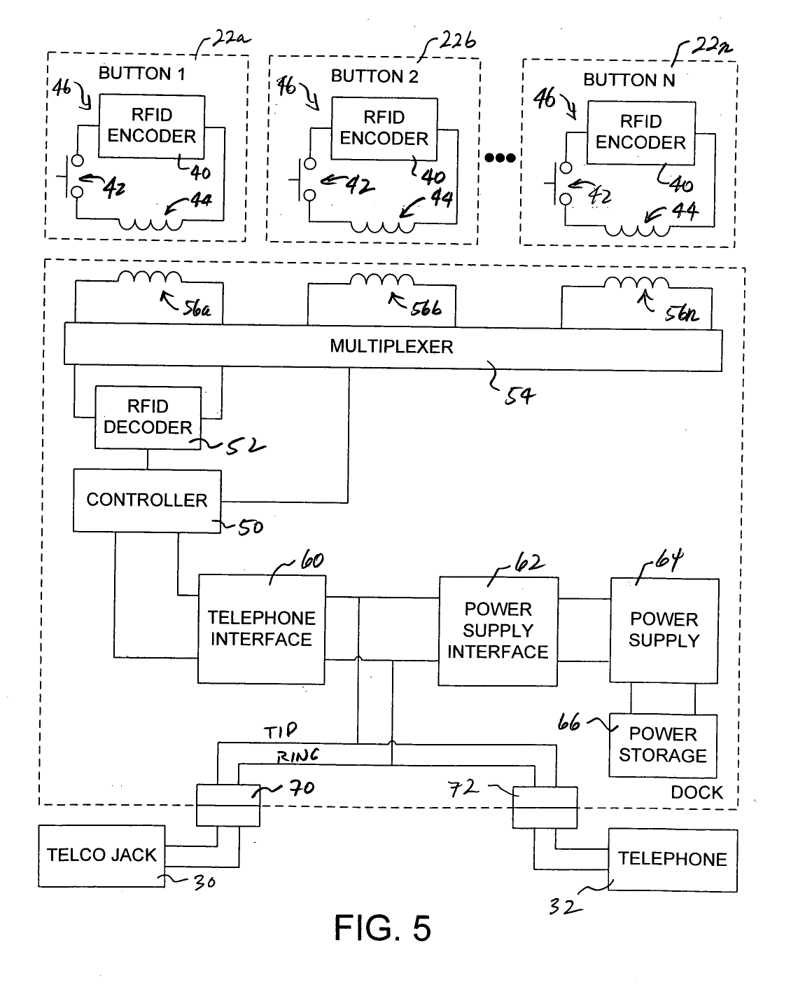

Referring now to FIG. 5 of the drawing, depicted at 20a therein is a fifth example data exchange system constructed in accordance with, and embodying, the principles of the present invention. The fifth example data exchange system 20a is substantially the same as the first example data exchange system 20 described above. Therefore, the same reference characters used in FIG. 1 to refer to components of the first example data exchange system 20 will be used in FIG. 5 to refer to like components of the fifth example data exchange system 20a.

The fifth example data exchange system 20a comprises a power storage element 66 connected to the power supply 64. The power signal carried by the TIP and RING lines is available only when the telephone is in its “off hook” state. The power storage element 66 allows the power supply 64 to store energy whenever the telephone is placed in the “off hook” state. Accordingly, the power supply 64 may be capable of handling greater loads when required using power stored in the power storage element 66. The power storage element 32 may be a rechargeable battery or other energy storage element such as a capacitor.

### VI. Sixth Example Data Exchange System

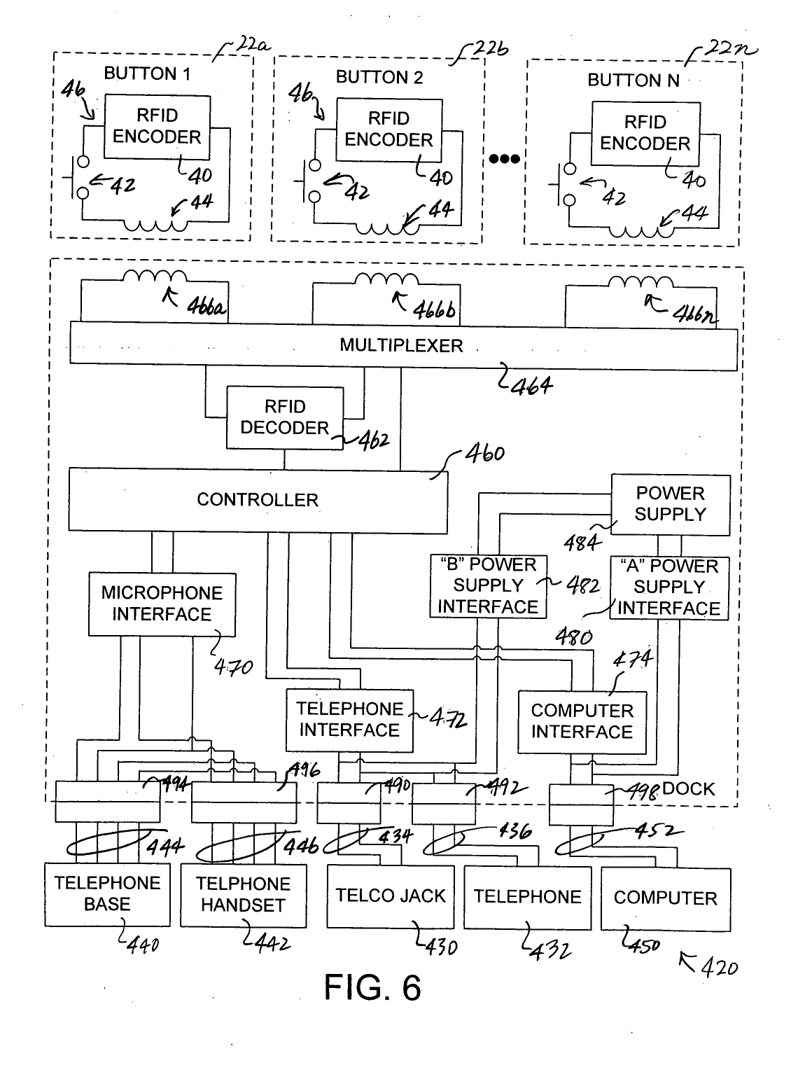

Referring now to FIG. 6 of the drawing, depicted at 420 therein is a second example data exchange system constructed in accordance with, and embodying, the principles of the present invention. The second example data exchange system 420 comprises a plurality of the button assemblies 22a, 22b, and 22n and a dock assembly 424. The button assemblies 22a-n described above may also be used in connection with the dock assembly 424 as will be described in further detail below.

As will be described in further detail below, the dock assembly 424 is connected between a PBX TELCO jack 430 and a digital telephone 432 by first and second cable assemblies 434 and 436. In the example system 420, the dock assembly 424 is additionally connected between a telephone base 440 and a telephone handset 442 by cables 444 and 446. The example system 420 is further connected by to a computer 450 by a cable 452.

The example dock assembly 424 comprises a controller 460, an RFID decoder 462, a multiplexer 464, and a plurality of dock coils 466a, 466b, and 466n. The example dock assembly 424 further comprises a microphone interface 470, a telephone interface 472, and a computer interface 474. The example dock assembly 424 further comprises an “A” power supply interface 480, a “B” power supply interface 482, and a power supply 484. The dock assembly 424 also comprises a first jack 490, a second jack 492, a third jack 494, a fourth jack 496, and a fifth jack 498.

The controller 460 operates the multiplexer 464 to connect a selected one of the dock coils 466 to the RFID decoder 462. The controller 460 further operates the RFID decoder 462 to energize the selected dock coil 466.

When the selected dock coil 466 is energized by the RFID decoder 462 as described above, the selected dock coil 466 transmits an RF power signal. If the button coil 444 of any one of the button assemblies 422a-n is within range of the RF power signal generated by the selected dock coil 466, any button coil 444 adjacent to the selected dock coil 466 converts the RF power signal into a current capable of energizing the RFID encoder 440 connected to the adjacent button coil 444.

If the switch 442 connected to the button coil 444 that receives the RF power signal is open, the antenna circuit 436 is not formed, and the RFID encoder 440 is not energized. If, however, the switch 442 connected to the button coil 444 that receives the RF power signal is closed, the antenna circuit 436 is formed, and the adjacent button coil 444 generates a current that energizes the RFID encoder 440. As described above, the RFID encoder 440 generates the RF data signal when energized. The adjacent button coil 444 transmits the RF data signal to the selected dock coil 466 adjacent thereto.

The selected dock coil 466 receives the RF data signal and converts the RF data signal into a current that is received by the RFID decoder 462 through the multiplexer 464. The RFID decoder 462 extracts from the RF data signal the data stored by the RFID encoder 440 connected to the adjacent button coil 444.

The RFID encoder 440 then passes the extracted data to the controller 460. In the example data exchange system 420, the extracted data corresponds to a telephone number or a portion of a telephone number. The controller 460 generates DTMF signals corresponding to the telephone number or portion of a telephone number. The controller 460 may generate the DTMF signals using conventional pulse-width modulation techniques or a DTMF generation system as will be described in further detail below.

The controller sends the DTMF signals either to the microphone interface 470 or to the telephone interface. The microphone interface conditions the DTMF signal as appropriate for application to the microphone lines of a conventional telephone. The telephone interface conditions the DTMF signal as appropriate for application to the voice lines of a digital phone. In either case, the DTMF signal is applied to the microphone lines such that, when the telephone base 440 is in the “off hook” state, the DTMF signals are passed through to the voice lines connected to the telephone base 440.

In addition to telephone number data, the extracted data may further contain contact information such as individual name, company name, address, and the like. The controller 460 further generates a digital data signal based on the extracted data, where the digital data signal contains the contact information. The controller 460 is connected to the computer interface 474 to transfer the digital data signal to the computer interface 474. The computer interface 474 in turn transfers the extracted data to the computing device 450 through the third port 498 and the third cable 452.

The example computing device 340 supports the USB or similar standards described above. The example cable 342 is a USB cable that carries a USB power signal and digital data. Accordingly, FIG. 6 further illustrates that the “A” power supply interface 480 is connected to the third jack 498 and generates a raw power supply signal based on the USB power signal. The “A” power supply interface 480 applies the raw power signal to the power supply 484. The power supply 484 converts the raw power signal into a system power supply signal appropriate for powering the controller 460, RFID decoder 462, microphone interface 470, telephone interface 472, and computer interface 474in a conventional manner. By obtaining power from the USB cable 342, the dock assembly 324 does not require utility or battery power.

However, FIG. 6 further illustrates that the first cable 434 is connected between the PBX TELCO jack 430 and the first jack 490, and the second cable 434 is connected between the second jack 492 and the digital telephone 432. Conductors carrying voice and power signals are thus available between the first and second jacks 480 and 482. The “B” power supply interface 480 is connected to the PBX power lines. The “B” power supply interface 482 generates a raw power supply signal and applies this raw power signal to the power supply 484. The power supply 484 converts the raw power signal into a system power supply signal appropriate for powering the controller 460, RFID decoder 462, microphone interface 470, telephone interface 472, and computer interface 474 in a conventional manner. If power is obtained from the PBX interface, the dock assembly 424 does not require utility or battery power.

The RFID encoder 440 and RFID decoder 462 are or may be conventional. The RFID system formed by the encoder 440 and decoder 462 can be used both to transmit data from the button assemblies 422 to the dock 424 and, under appropriate conditions, from a conventional RFID programming system to the RFID encoder 440 of the button assemblies 422. Alternatively, data may be stored directly onto the RFID encoder 440 using electrical contacts.

The data exchange system 420 allows a single unit to be shipped that can be configured to work with a PBX telephone system, a computing device, where power is available from one or both of the telephone line and the computing device. If both power supplies are available, the “A” power supply interface 480 will be used, as power is available as long as the USB bus system is operating and not only when the phone lines are in the “off hook” state.

### VII. Example Telephony Interface Circuit

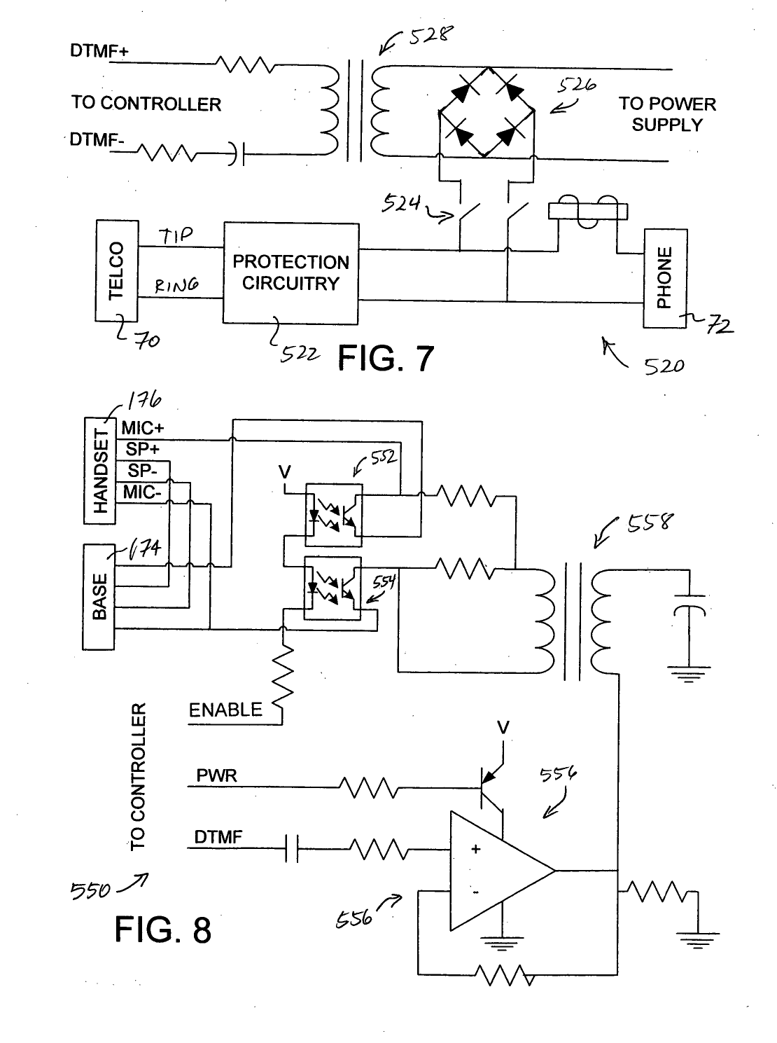

Referring now to FIG. 7, depicted therein is an example telephony interface circuit 520 that implements the both the telephone interface 60 and the power supply interface 62 of the first example data exchange system 20.

The telephony interface circuit 520 illustrates that the TIP and RING lines pass from the TELCO jack 70 through protection circuitry 522 to the phone jack 72. A magnetic switch 524 is arranged in a normally open configuration and closes when current flows through the TIP line. Power passes through the switch 524 and a rectifier circuit 526 and to the power supply 64. The DTMF+ and DTMF− signals pass through buffering elements and an isolation transformer 528 and back through the switch 524 to the TIP and RING lines.

### VIII. Example Microphone Interface Circuit

Referring now to FIG. 8, depicted therein is an example microphone interface circuit 550 that may be used as the microphone interface circuit 160 of the second example data exchange system 120.

The microphone interface circuit 550 illustrates that the MIC+, SP+, SP−, and MIC− lines pass between the handset jack 176 and the base jack 174. The SP+ and SP− lines pass straight through the circuit 550. The MIC+ and MIC− minus lines are switched to the DTMF generation circuitry by optocouplers 552 and 554 when activated by the ENABLE signal. The DTMF signal is amplified by an amplifier circuit 556, passed through a transformer 558, and then back to the optocouplers 552 and 554. A PWR signal turns the amplifier circuit off when the circuit 550 is not in use. The DTMF signals are thus injected into the MIC+ and MIC− lines at a level appropriate for the circuitry in the telephone base 140 to apply these signals to the PBX voice lines.

### IX. Example DTMF Generation System

The generation of DTMF tones by any of the controllers described above will now be described in further detail. Table A set forth below contains an industry-standard DTMF tone matrix that represents the relationship between frequencies and digits:

TABLE A

| LOW/HIGH | 1209 Hz | 1336 Hz | 1477 Hz | 1633 Hz |
|---|---|---|---|---|
| 697 Hz | 1 | 2 | 3 | A |
| 770 Hz | 4 | 5 | 6 | B |
| 852 Hz | 7 | 8 | 9 | C |
| 941 Hz | * | 9 | # | D |

More specifically, a DTMF signal is a composite signal comprising one of the LOW frequencies and one of the HIGH frequencies. For example, a DTMF signal associated with the digit “2” comprises a first or LOW sine wave having a frequency of 697 Hz and a second or HIGH sine wave having a frequency of 1336 Hz.

To represent analog DTMF signals with digital circuitry, the controller stores sets of frequency data in the form of series of numbers that each represents one of seven of the eight frequencies contained in Table A; the eighth frequency, 1633 Hz, is only used to represent letters and is thus omitted.

In particular, a Table B, which forms part of this specification, is appended hereto as Exhibit A. The third through ninth columns in the Table B each contain the series of numbers that represent one of the seven frequencies used to form DTMF signals. The first column contains a sequential sample number from 1 to 78, and the second column contains a number representing time in increments of 55 microseconds.

The numbers in Table B generally correspond to the amplitude of a sine wave having the frequency identified at the top of Table B at a number of points in the cycle of the waveform. A plot or other reproduction of these numbers at the time intervals in the second column will yield a representation of a sine wave of the desired frequency.

All of the number series are repeated for the signal duration of a given DTMF signal; this signal duration corresponds to the durations of the periods T₁, T₂, and T₃ described above. Several of the number sequences are stored several times in Table B to improve reproduction of a composite signal, which is calculated as will be described below. The number of samples reproduced in Table B is set at 78 to show all of the repeated number sequences.

To obtain a composite signal, the numbers in two of the columns of Table B are added to obtain composite data. For example, to create composite data associated with the digit “2”, the numbers associated with the frequencies 697 Hz and 1336 Hz are added together for each sample period. For the digit “2”, the composite number associated with the first sample is 1+1, or 2. The composite number associated with the tenth sample period is 35+11, or 46. These calculations are repeatedly performed throughout the signal duration, and the repeated series reduce distortions in the resulting composite signal.

The numbers representing the composite data calculated as just described generally correspond to the amplitude of a composite signal comprised of the frequencies 697 Hz and 1336 Hz at a number of points in the cycle of the waveform of the composite signal. A plot or other reproduction of these numbers at the time intervals in the second column will thus yield a representation of a composite signal.

Again, if the controller contains a digital to analog converter, the composite signal could be generated directly from the composite data calculated as described above. For processors like the exemplary controller that do not have the capacity to generate an analog signal, the composite data may be used as a pulse-width modulated signal that represents the analog composite signal.

The present invention implements a digital pulse-width modulation technique as follows. The composite data is stored within the controller in the form of an eight-bit bye, with only least significant six bits being used to represent the composite signal. The use of six significant bits yields 64 possibilities, and the highest numbers in Table B do not add up to a composite number that is greater than 64.

The six significant bits of the composite numbers calculated as described above are used to determine the state of the output signal of the controller (e.g., between DTMF+ and DTMF−). In particular, the first bit determines the output signal at cycle 0 of a 64 cycle period. The second bit determines the output signal at cycles 1 and 2 of the 64 cycle period. The third bit determines the output signal at cycles 3-7 of the 64 cycle period. The fourth bit determines the output signal at cycles 8-15 of the 64 cycle period. The fifth bit determines the output signal at cycles 16-31 of the 64 cycle period. The sixth bit determines the output signal at cycles 32-63 of the 64 cycle period.

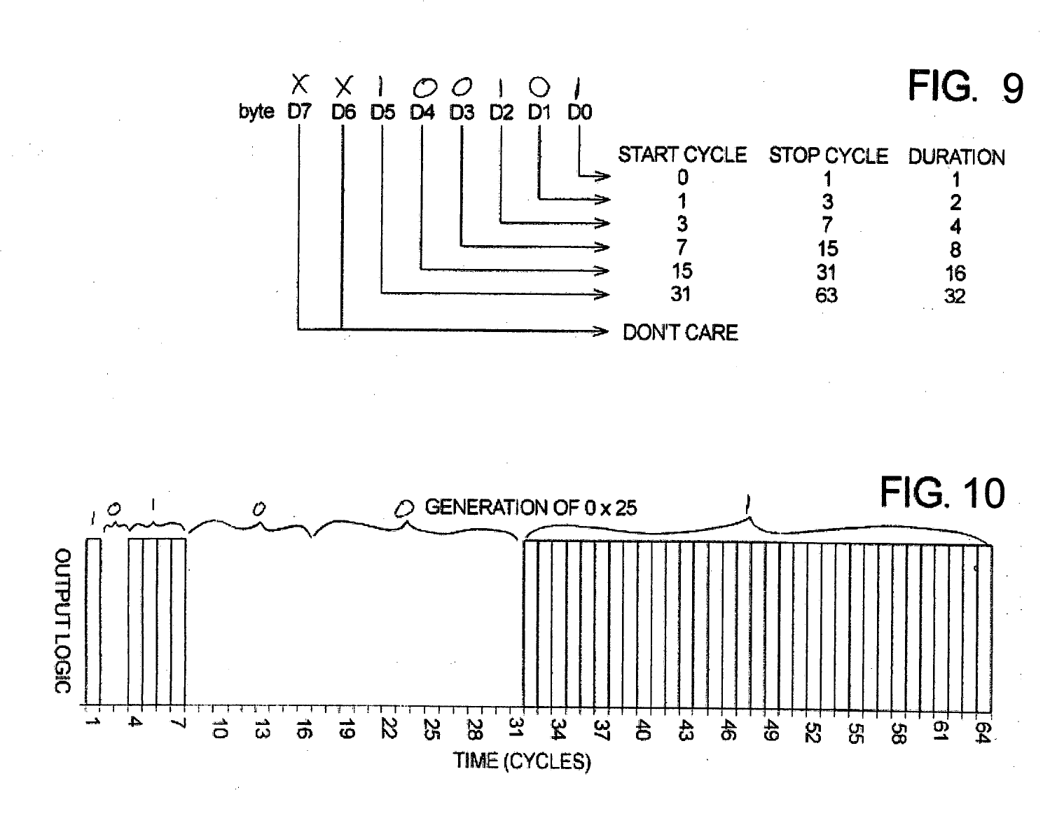

An example of this process is depicted in FIGS. 9 and 10. These figures illustrate the generation of the output logic signal given the example of a composite number equaling the hexadecimal number 0×25 (decimal: 37; binary: XX100101). The resulting digital output signal is shown in FIG. 10. The total length of the 64 cycle period is much less than the signal durations T₁, T₂, and T₃ described above.

### X. Seventh Example Data Exchange System

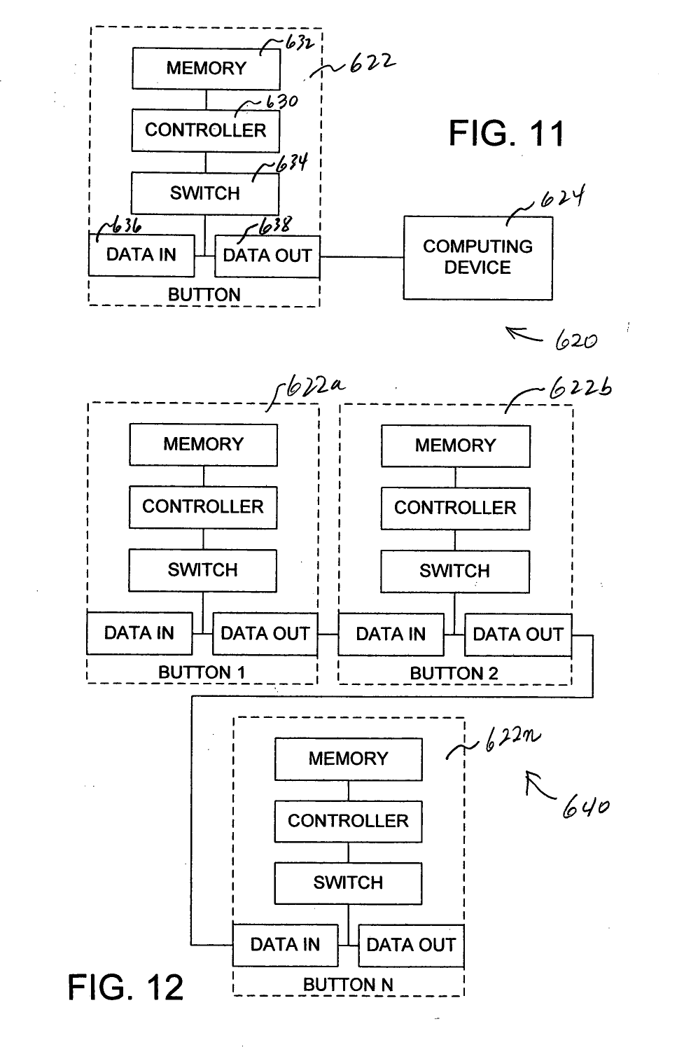

Referring now to FIG. 11, depicted therein is data exchange system 620 comprising a button device 622 and a computing device 624. The computing device 624 may be a general purpose computer, personal digital assistant, cellular telephone, camera, MP3 player, or any other device capable of receiving digital data.

The button device 622 comprises a controller 630, a memory device 632, a switch 634, and data in and data out ports 636 and 638. In the example system, the switch 634 is configured to allow the user to control flow of data into and out of the controller 630 through the ports 636 and 638. The computing device 624 is configured to display a user interface that allows access to the data in the memory device 632 when the switch 634 is closed. When connected to a computing device such as the device 624, the button may obtain power from the host computing device.

In FIG. 12, a plurality of the buttons 622a, 622b, through 622n are daisy chained together to form a data exchange system 640 that allows data to be transferred among the various buttons 622 when one or more of the switches 634 are activated.

The buttons 622 thus allow the exchange of personal information, such as individual name, company name, address, songs, video clips, audio clips, resume data, playlist data, and the like, but only under control of the user.

### XI. Summary

In general, the present invention allows the user of the button assemblies 22 to control when the data stored thereon is downloaded by requiring that the switch 42 be closed to allow the antenna circuit 46 to be formed. The button assemblies may be discrete or may be incorporated as part of another structure such as a business card, credit card, identification card, or the like. To this end, security can also be enhanced by designing the antenna circuit 46 such that the button assembly must be within a first range of less than approximately three inches, within a second range of less than approximately one inch, and in the preferred embodiments approximately one-half inch.

More specifically, the present invention allows data to be distributed and downloaded for use in a variety of host systems, such as telephones and computing devices, without modification of the host system.

The present invention may thus be embodied in many forms other than those depicted and described herein. The scope of the present invention should be determined based on the claims appended hereto and not the foregoing detailed description.

TABLE B

| | | f = freq (Hz) | f = freq (Hz) | f = freq (Hz) | f = freq (Hz) | f = freq (Hz) | f = freq (Hz) | f = freq (Hz) |
|---|---|---|---|---|---|---|---|---|
| | | Desired Freq (Hz) | | | | | | |
| | | 697 | 770 | 852 | 941 | 1209 | 1336 | 1477 |
| | | Actual Freq (Hz) | | | | | | |
| Sample | t = Time(s) | 696 | 770 | 848 | 940 | 1206 | 1340 | 1477 |
| 1 | 5.5263E-05 | 1 | 1 | 1 | 1 | 1 | 1 | 1 |
| 2 | 0.00011053 | 2 | 2 | 3 | 3 | 3 | 4 | 5 |
| 3 | 0.00016579 | 5 | 6 | 7 | 6 | 7 | 9 | 10 |
| 4 | 0.00022105 | 8 | 10 | 12 | 11 | 12 | 14 | 16 |
| 5 | 0.00027632 | 13 | 15 | 18 | 16 | 16 | 18 | 20 |
| 6 | 0.00033158 | 18 | 21 | 24 | 21 | 19 | 21 | 22 |
| 7 | 0.00038684 | 22 | 26 | 30 | 26 | 21 | 21 | 20 |
| 8 | 0.00044211 | 27 | 31 | 35 | 29 | 21 | 20 | 17 |
| 9 | 0.00049737 | 32 | 35 | 38 | 31 | 19 | 16 | 12 |
| 10 | 0.00055263 | 35 | 38 | 40 | 31 | 16 | 11 | 6 |
| 11 | 0.00060789 | 38 | 40 | 40 | 29 | 12 | 6 | 2 |
| 12 | 0.00066316 | 40 | 40 | 39 | 26 | 7 | 2 | 1 |
| 13 | 0.00071842 | 40 | 39 | 36 | 22 | 3 | 1 | 1 |
| 14 | 0.00077368 | 40 | 37 | 31 | 17 | 1 | 1 | 4 |
| 15 | 0.00082895 | 38 | 33 | 26 | 12 | 0 | 4 | 9 |
| 16 | 0.00088421 | 35 | 29 | 20 | 7 | 1 | 6 | 14 |
| 17 | 0.00093947 | 32 | 23 | 14 | 3 | 3 | 11 | 19 |
| 18 | 0.00099474 | 27 | 18 | 8 | 1 | 7 | 16 | 21 |
| 19 | 0.00105 | 22 | 13 | 4 | 1 | 12 | 20 | 21 |
| 20 | 0.00110526 | 17 | 8 | 1 | 1 | 16 | 21 | 18 |
| 21 | 0.00116053 | 13 | 4 | 1 | 2 | 20 | 21 | 13 |
| 22 | 0.00121579 | 8 | 1 | 1 | 6 | 21 | 18 | 7 |
| 23 | 0.00127105 | 5 | 1 | 2 | 10 | 21 | 14 | 3 |
| 24 | 0.00132632 | 2 | 1 | 6 | 15 | 19 | 9 | 1 |
| 25 | 0.00138158 | 1 | 1 | 11 | 20 | 16 | 4 | 1 |
| 26 | 0.00143684 | 0 | 4 | 17 | 25 | 11 | 1 | 3 |
| 27 | 0.00149211 | 0 | 8 | 23 | 28 | 7 | 0 | 7 |
| 28 | 0.00154737 | 2 | 13 | 29 | 30 | 3 | 1 | 13 |
| 29 | 0.00160263 | 5 | 18 | 34 | 31 | 0 | 7 | 18 |
| 30 | 0.00165789 | 9 | 23 | 37 | 30 | 0 | 8 | 21 |
| 31 | 0.00171316 | 13 | 29 | 40 | 27 | 2 | 13 | 21 |
| 32 | 0.00176842 | 18 | 33 | 40 | 23 | 7 | 18 | 19 |
| 33 | 0.00182368 | 23 | 37 | 39 | 19 | 7 | 21 | 14 |
| 34 | 0.00187895 | 27 | 39 | 36 | 13 | 12 | 22 | 9 |
| 35 | 0.00193421 | 32 | 40 | 32 | 9 | 16 | 20 | 4 |
| 36 | 0.00198947 | 35 | 40 | 27 | 4 | 20 | 17 | 1 |
| 37 | 0.00204474 | 38 | 38 | 21 | 1 | 21 | 12 | 1 |
| 38 | 0.0021 | 40 | 35 | 15 | 1 | 21 | 7 | 2 |
| 39 | 0.00215526 | 40 | 31 | 9 | 1 | 19 | 3 | 6 |
| 40 | 0.00221053 | 40 | 26 | 5 | 1 | 16 | 0 | 12 |
| 41 | 0.00226579 | 38 | 21 | 1 | 5 | 11 | 0 | 17 |
| 42 | 0.00232105 | 35 | 15 | 1 | 9 | 7 | 2 | 20 |
| 43 | 0.00237632 | 31 | 10 | 1 | 14 | 3 | 11 | 22 |
| 44 | 0.00243158 | 27 | 6 | 2 | 19 | 0 | 10 | 20 |
| 45 | 0.00248684 | 22 | 2 | 5 | 24 | 0 | 15 | 16 |
| 46 | 0.00254211 | 17 | 1 | 10 | 28 | 1 | 19 | 10 |
| 47 | 0.00259737 | 12 | 0 | 15 | 30 | 7 | 21 | 5 |
| 48 | 0.00265263 | 8 | 0 | 21 | 31 | 15 | 21 | 1 |
| 49 | 0.00270789 | 4 | 2 | 27 | 30 | 12 | 19 | 0 |
| 50 | 0.00276316 | 2 | 6 | 32 | 28 | 16 | 14 | 1 |
| 51 | 0.00281842 | 0 | 10 | 37 | 24 | 20 | 9 | 5 |
| 52 | 0.00287368 | 0 | 15 | 39 | 20 | 21 | 5 | 10 |
| 53 | 0.00292895 | 0 | 21 | 40 | 15 | 21 | 1 | 16 |
| 54 | 0.00298421 | 2 | 26 | 40 | 10 | 19 | 0 | 20 |
| 55 | 0.00303947 | 5 | 31 | 37 | 5 | 16 | 0 | 22 |
| 56 | 0.00309474 | 9 | 35 | 33 | 2 | 11 | 3 | 20 |
| 57 | 0.00315 | 13 | 38 | 28 | 1 | 7 | 8 | 17 |
| 58 | 0.00320526 | 18 | 40 | 22 | 1 | 3 | 13 | 12 |
| 59 | 0.00326053 | 23 | 40 | 16 | 1 | 0 | 17 | 6 |
| 60 | 0.00331579 | 28 | 39 | 11 | 4 | 0 | 20 | 2 |
| 61 | 0.00337105 | 32 | 37 | 6 | 8 | 1 | 22 | 0 |
| 62 | 0.00342632 | 36 | 33 | 2 | 13 | 4 | 20 | 0 |
| 63 | 0.00348158 | 38 | 29 | 1 | 18 | 8 | 17 | 4 |
| 64 | 0.00353684 | 40 | 23 | 0 | 23 | 12 | 12 | 9 |
| 65 | 0.00359211 | 40 | 18 | 1 | 27 | 17 | 7 | 14 |
| 66 | 0.00364737 | 40 | 13 | 4 | 30 | 20 | 3 | 19 |
| 67 | 0.00370263 | 38 | 8 | 8 | 31 | 21 | 0 | 21 |
| 68 | 0.00375789 | 35 | 4 | 14 | 31 | 21 | 0 | 21 |
| 69 | 0.00381316 | 31 | 1 | 20 | 29 | 19 | 1 | 18 |
| 70 | 0.00386842 | 27 | 0 | 26 | 25 | 15 | 5 | 13 |
| 71 | 0.00392368 | 22 | 0 | 31 | 21 | 11 | 10 | 7 |
| 72 | 0.00397895 | 17 | 1 | 36 | 16 | 6 | 15 | 3 |
| 73 | 0.00403421 | 12 | 4 | 39 | 11 | 3 | 19 | 0 |
| 74 | 0.00408947 | 8 | 8 | 40 | 6 | 0 | 21 | 0 |
| 75 | 0.00414474 | 4 | 13 | 40 | 2 | 0 | 21 | 3 |
| 76 | 0.0042 | 2 | 18 | 38 | 1 | 1 | 19 | 7 |
| 77 | 0.00425526 | 0 | 23 | 34 | 0 | 4 | 15 | 13 |
| 78 | 0.00431053 | 0 | 29 | 30 | 1 | 8 | 10 | 18 |

We claim:

1. A data exchange system for exchanging data with a host device, comprising:
at least one button assembly comprising an encoder, a button coil, and a switch, where closing the switch forms an antenna circuit;
a dock assembly comprising a controller, at least one dock coil, a decoder, and at least one interface; whereby
the controller
causes the decoder to obtain data from the encoder through the button coil and the dock coil when the switch is closed, and
transfers the data to the at least one interface; and
the at least one interface transfers the data to the host device.

2. A data exchange system as recited in claim 1, further comprising a plurality of button assemblies, wherein:
the dock assembly further comprises a multiplexer and a plurality of dock coils;
each button assembly is arranged adjacent to one of the dock coils; and
the controller operates the multiplexer to connect the decoder to a selected one of the dock coils.

3. A data exchange system as recited in claim 1, in which the interface is a telephone interface.

4. A data exchange system as recited in claim 1, in which the interface is a microphone interface.

5. A data exchange system as recited in claim 1, in which the interface is a computer interface.

6. A data exchange system as recited in claim 3, further comprising a computer interface.

7. A data exchange system as recited in claim 6, further comprising a microphone interface.

8. A data exchange system as recited in claim 5, further comprising a microphone interface.

9. A data exchange system as recited in claim 1, in which the button assembly obtains power from the dock assembly.

10. A data exchange system as recited in claim 1, in which the dock assembly obtains power from the host device.

11. A data exchange system as recited in claim 9, in which the dock assembly obtains power from the host device.

12. A method of exchanging data with a host device, comprising the steps of:
providing at least one button assembly comprising an encoder, a button coil, and a switch;
closing the switch to form an antenna circuit to place the button assembly in a data transfer mode;
providing a dock assembly comprising at least one dock coil, a decoder, and at least one interface;
causing the decoder to obtain data from the encoder through the button coil and the dock coil when the button assembly is in the data transfer mode, and
transferring the data to the at least one interface; and
transferring the data from the at least one interface transfers to the host device.

13. A method as recited in claim 12, further comprising the steps of:
providing a plurality of button assemblies;
providing the dock assembly with a multiplexer and a plurality of dock coils;
arranging each of the plurality of button assemblies adjacent to one of the dock coils; and
operating the multiplexer to connect the decoder to a selected one of the dock coils.

14. A method as recited in claim 12, further comprising the step of configuring the button assembly to obtain power from the dock assembly.

15. A method as recited in claim 12, further comprising the step of configuring the dock assembly to obtain power from the host device.

16. A method as recited in claim 14, further comprising the step of configuring the dock assembly to obtain power from the host device.

17. A data exchange system for exchanging data with a host device, comprising:
a dock assembly comprising a controller, a plurality of dock coils, a decoder, a multiplexer, and at least one interface, where the dock assembly obtains power from the host device;
a plurality of button assemblies each comprising an encoder, a button coil, and a switch, where closing the switch forms an antenna circuit, where the button assemblies obtain power from the dock assembly; whereby
the controller
causes the multiplexer to connect the decoder to a selected one of the dock coils;
causes the decoder to obtain data from the encoder through the button coil and the selected dock coil when the switch is closed, and
transfers the data to the at least one interface; and
the at least one interface transfers the data to the host device.

18. A data exchange system as recited in claim 17, in which the interface is a telephone interface.

19. A data exchange system as recited in claim 17, in which the interface is a microphone interface.

20. A data exchange system as recited in claim 17, in which the interface is a computer interface.
